(19) United States
(12) Patent Application Publication
(10) Pub. No.: US 2012/0275315 A1
(43) Pub. Date: Nov. 1, 2012

(54) PHYSICAL-LAYER CELL IDENTITY (PCI) CONFLICT DETECTION

(75) Inventors: Thomas J. Schlangen, Chandler, AZ (US); Mimi H. Hutchison, Keller, TX (US); Paul M. Stephens, Swindon (GB)

(73) Assignee: MOTOROLA SOLUTIONS, INC., Schaumburg, IL (US)

(21) Appl. No.: 13/095,322

(22) Filed: Apr. 27, 2011

(51) Int. Cl. H04W 24/00; H04L 12/26; H04W 4/00

(52) U.S. Cl. 370/242; 370/328

(57) ABSTRACT

Physical layer cell identity (PCI) misconfiguration in a self-organizing network (SON) (100) can be detected (168). An automatic neighbor relations (ANR) function (225) can execute at an eNodeB cell (210) of a long term evolution (LTE) telecommunications network (122, 124, 126). This execution can cause the eNodeB (210) to detect misconfiguration (168) of physical layer cell identity (PCI) values by causing a sample of user equipment (UE) (112, 114,116) to convey PCI values (146) of neighboring cells to the eNodeB cell (124), which the eNodeB cell uses to detect PCI confusion or PCI collision situations (168). In one embodiment, the ANR function (225) can leverage a reportCGI trigger (227) for UE measurement reporting.

### FIELD OF THE INVENTION

The present invention relates to the field of mobile telephony networks and, more particularly, to physical-layer cell identity (PCI) conflict detection.

### BACKGROUND

Fourth generation (4G) networks are designed to be backwards compatible with pre-4G and 3G (for “third generation”). Thus, 3G, pre-4G, and 4G networks can conform to specifications embodied in the global International Telecommunication Union (ITU) International Mobile Telecommunications-2000(IMT-2000) specification. IMT-2000 includes the 3rd Generation Partnership Project (3GPP) specification. Because of backwards compatibility, solutions compatible with the 3GPP specification are compatible across 3G, pre-4G, and 4G networks, while requirements and solutions in conformance of only a 4G specification may not function in 3G, pre-4G, or hybrid environments.

For example, in some 4G networks, such as a long term evolution (LTE) network, a Physical Layer Cell Identity (PCI or Cell ID) can be used for cell identification and channel synchronization. Many 4G solutions utilize this PCI value to uniquely identify a base station node. Unfortunately, the 3rd Generation Partnership Project (3GPP) standards do not guarantee detection of PCI conflicts. Until these PCI conflicts are detected and resolved, significant radio interference can occur, which can result in complete loss of service in impacted coverage areas.

### SUMMARY

One embodiment of the disclosure includes a system for a base station node (eNodeB) of a long term evolution (LTE) of a mobile telecommunication system. In the system, the eNodeB can include at least one transmitter and at least one receiver for wirelessly transmitting and receiving digitally encoded content to and from user equipment (UE) via radio frequency signals over the LTE compliant network. The eNodeB can also include computer program instructions digitally encoded in at least one storage medium. The computer program instructions implement a self-organizing network (SON) automatic neighbor relationship (ANR) function to detect physical layer cell identity (PCI) confusion or PCI collision situations. In one embodiment, the ANR function can leverage a reportCGI trigger, to cause user equipment (UE) to report PCI and E-UTRAN Cell Global Identifier (ECGI) values for base stations in range of the UE.

Another embodiment of the disclosure can include a method for detecting physical-layer cell identity (PCI) conflicts. In this aspect, a base station node of a wireless mobile telecommunication system can trigger a set of user equipment (UE) within radio frequency range of the base station node to determine neighbor base station nodes also in radio frequency range of the corresponding UE. Responses from the set user equipment (UE) can be received at the base station node. Each of the responses can indicate at least one neighboring base station node by an E-UTRAN Cell Global Identifier (ECGI) and by a corresponding physical-layer cell identity (PCI) value. A PCI conflict between nodes can be detected whenever two nodes having different ECGI values have the same PCI value.

Another embodiment of the disclosure can include a method for detecting physical-layer cell identity (PCI) conflicts in a self-organizing network (SON). In this method, an automatic neighbor relations (ANR) function can execute at an eNodeB cell of a long term evolution (LTE) telecommunications network. This execution can cause the eNodeB to detect misconfiguration of physical layer cell identity (PCI) values by causing a sample of user equipment (UE) to convey PCI values of neighboring cells to the eNodeB, which the eNodeB uses to detect PCI confusion or PCI collision situations. In one embodiment, the ANR function can leverage a reportCGI trigger for UE measurement reporting.

### BRIEF DESCRIPTION OF THE SEVERAL VIEWS OF THE DRAWINGS

FIG. 1 is a block diagram of a system for Physical Layer cell ID (PCI) conflict detection through user equipment (UE) sampling in accordance with an embodiment of the inventive arrangements disclosed herein.

FIG. 2 shows a block diagram of a base station node and a mobile device in accordance with an embodiment of the inventive arrangements disclosed herein.

FIG. 3 illustrates an example of a method for detection of PCI conflicts via UE measurement sampling in a Long Term Evolution (LTE) network in accordance with an embodiment of the inventive arrangements disclosed herein.

### DETAILED DESCRIPTION

In accordance with various embodiments, an apparatus and techniques are provided herein for detecting Physical Layer cell ID (PCI) confusion or PCI collision situations in a 4G telecommunications network. In one embodiment, the apparatus and techniques leverage a 3rd Generation Partnership Project (3 GPP) compliant Automatic Neighbor Relationship (ANR) function (e.g., a Cell Global Identity (CGI) reporting trigger, referred to herein as reportCGI) in a novel way.

Conventionally, user equipment (UE) sends a signal strength measure to a base station (e.g., eNodeB cell) of a 4G network. This signal strength measurement has one or more unknown PCI values (i.e., a PCI value that has not been previously resolved into the unique neighbor identity, such as an E-UTRAN Cell Global Identifier or ECGI). In one embodiment, the eNodeB can invoke the reportCGI procedure, which requests that the UE to listen to the neighbor cell, learn its ECGI value, and report this value back to the requesting cell. The eNodeB can then compare the ECGI value with the “known” ECGI value in its database. If the two ECGI values are different, then the eNodeB has discovered a PCI conflict. Actions to resolve this PCI conflict can then be optionally taken.

In accordance with an embodiment, the UE can send a signal strength measurement to the eNodeB cell with one or more “known” PCI values (i.e., a PCI value that has already been resolved into the unique neighbor identity or ECGI). The eNodeB cell can invoke the ReportCGI procedure, which requests the UE to listen to the neighbor cell, learn its ECGI value, and report it back to the requesting cell. The eNodeB cell can then compare the ECGI value with the “known” ECGI value in its database. If the two ECGI values are different, then the eNodeB cell has discovered a PCI conflict. Actions to resolve this PCI conflict can be optionally taken.

In one embodiment, a sampling mechanism can be implemented so that only a sample of UE are requested to listen to neighbor cells, learn their ECGI and PCI values, and report these values back to the requesting eNodeB cell. Use of a suitably sized sample ensures PCI conflicts are detected, while incurring minimal expense in terms of eNodeB CPU utilization and UE battery life.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-transitory medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

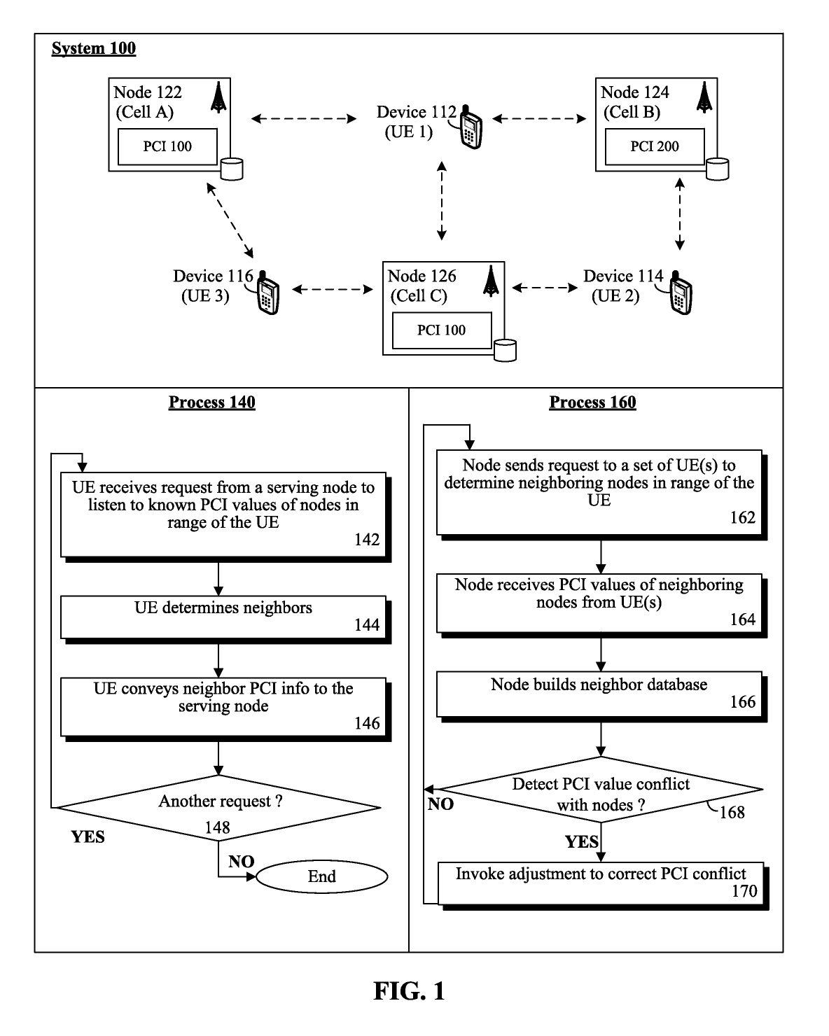

FIG. 1 is a block diagram of a system 100 for Physical Layer cell ID (PCI) conflict detection through user equipment (UE) sampling in accordance with an embodiment of the inventive arrangements disclosed herein.

The system 100 can be a mobile telecommunication network having nodes 122, 124, 126 with PCI values 100, 200, and 100, respectively. The mobile telecommunications network can conform to third generation (3G), pre-fourth generation (pre-4G), and/or fourth generation (4G) for mobile telecommunication networks standards. More specifically, in one embodiment, the mobile communication network can conform to 3rd Generation Partnership Project (3GPP) long term evolution (LTE) standards.

In system 100, multiple base station nodes 122, 124, and 126 wirelessly communicate with a set of devices 112, 114, and 116. Each base station node 122, 124, 126 can have a node specific Physical Layer Cell ID (PCI) value.

Each device 112, 114, 116 can be a communication device with a wireless transceiver (e.g., 3G or 4G transceiver) able to connect to and exchange information via the mobile communication network via the nodes 122, 124, 126. Devices 112, 114, 116 can include, but are not limited to, a mobile telephone, two-way radio equipment with cellular capability, a tablet computing device, an e-book reader with cellular capability, a notebook, netbook, an internet device, a navigation device equipped for cellular communication, and the like. Device 112, 114, 116 can conform to 3GPP specifications and/or derivatives thereof.

The PCI value can be used for cell identification and channel synchronization. The PCI can be divided into two parts of one physical layer cell id group value and one physical layer cell id sector value. The PCI group value can have a range from zero to one hundred and sixty-seven. The PCI sector can have a range of values between zero and two. Thus, there are five hundred and four unique PCI values.

Processes 140 and 160 graphically show steps able to be performed by the devices 112, 114, 116 and nodes 122, 124, 126, respectively. Process 140 can begin in step 142, where, a UE (e.g., device 112, 114, 116) can receive a request from a serving node of a mobile telecommunication network (e.g., node 122, 124, or node 126). The request can instruct the UE to listen for known PCI values of nodes (122, 124, and/or 126) in range of the UE. A sample of UEs can be selected in step 142 in accordance with a sampling mechanism.

In step 144, the UE can determine the neighboring nodes. For example, the UE can send a signal strength measurement to a neighboring cell with one or more “known” values. The UE can learn both the PCI value and a unique neighbor ID (e.g., an E-UTRAN Cell Global Identifier or ECGI) of the neighbor cell. In step 146, the UE can convey the PCI values of one or more neighbor nodes to the serving node, which sent the request to listen to the UE. If another request is received by the UE (or by a different UE) in step 148, process 140 can progress to step 142.

Process 160 can begin in step 162, where a node invokes a ReportCGI procedure, which requests a sample of UEs to listen to a neighbor cell, learn its PCI and ECGI value, and then report these values back. It should be noted that the reportCGI procedure is being used in step 162 to report cells with “known” PCI values. In step 164, the node can receive PCI values and ECGI values of the neighboring nodes within responses from one or more of the UEs in range of the node. In step 166, the node can use the received PCI and ECGI values to build and/or update a neighbor database (broadly representing any data set, table, or other such structure capable of storing the PCI values). In step 168, a PCI value conflict may or may not be detected. When a reported PCI value has an ECGI value different from what is expected, a PCI conflict exits. (i.e., an ECGI value associated with a PCI in the neighbor database differs from the ECGI value reported by the UE). When no PCI value is detected, the process progresses from step 168 to step 162. When a conflict exists, step 170 can optionally execute, where an adjustment can be invoked to prevent the conflict. For example, the node can change the corresponding PCI value to a value different from any of the neighboring nodes in the neighbor database.

Handover decisions among the nodes 122, 124, 126 in the mobile telecommunication network of system 100 can be made based on neighbor cell measurements. These measurements are sent by the UE 112, 114, 116. In an illustrative use-case, Node 124 having a PCI value of two hundred can receive a UE measurement report from device 112 (UE1) that indicates it is currently connected to the network through node 122 having a PCI value of 100. Node 124 can request that one or more proximate devices (device 112-116) provide PCI values of neighbor nodes (e.g., step 142, 162).

Should a measurement report correspond to node 122, which is consistent with the sampled neighbor information, and then no PCI conflict situation exists. Thus, if a UE that responds to the request identifies node 122 as having a PCI value of one hundred (which is expected, since node 122 is already a neighbor of node 124), no further action is required (e.g., no PCI conflict detected as per step 168 progressing directly to step 162).

Should PCI values be returned from nodes that were not previously known, then these values can be added to the neighbor database maintained by the serving node (e.g., node 124).

In one situation, however, the node 124 can receive neighbor information that indicates two different nodes (e.g., node 122 and node 126) have the same PCI value (e.g., a PCI value 122 and 126 of one hundred). This situation is problematic, as it can result in handover problems. For example, if node 124 attempts to handover a device 116 to a node with a PCI value of one-hundred, device 116 may be unable to determine whether it should use node 122 or node 126 to connect to the mobile telephony network. Stated differently, upon receipt of a UE measurement report from device 116, node 124 may be unable to determine whether the measurement information is associated with node 122 or node 126.

Consequently because of the PCI conflict, device 116 may be unable to receive service due to radio interference. This is true for all UE in an overlapping coverage area between node 122 and node 126, due to PCI collision. Severe PCI collision states at a physical layer (of the Open Systems Interconnect or OSI model) may make it impossible for devices or UE in the overlapping coverage area to properly communicate with either node 122, 126.

The arrangements detailed herein can be used to resolve the above problems. Specifically, when node 162 receives neighbor information that indicates two different nodes have the same PCI value, an adjustment can be invoked to correct this PCI conflict (as noted by step 170). For example, the conflict detected by node 124 can be reported by node 124. Once apprised of the conflict, (e.g., upon receiving a message of the PCI conflict from node 124), adjustments in the network can be invoked by appropriate components to ensure that at least one of node 122 and node 126 are reassigned a PCI value 122, 126 with does not conflict with a neighbor node. For example, in one embodiment, a self-organizing network (SON) automated PCI function can be triggered to resolve the PCI confusion problem. In a SON embodiment, the nodes can be enabled to dynamically adjust their own PCI values via the SON automated PCI function. In another embodiment, a PCI server attached to the mobile telephony network can receive the conflict message from node 124 and can responsively send commands to one or more of nodes 122, 126 to adjust the PCI values, 126 to resolve the PCI conflict.

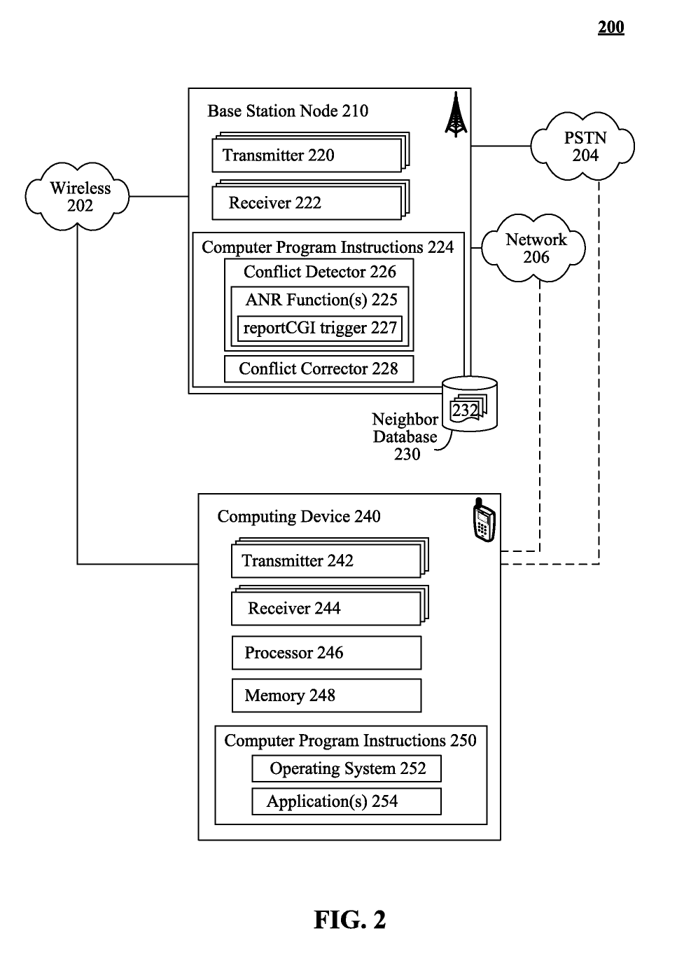

FIG. 2 shows a block diagram 200 of a base station node 210 and a mobile device 240 in accordance with an embodiment of the inventive arrangements disclosed herein. In one embodiment, the nodes 122, 124, 126 of FIG. 1 can be implemented in accordance with specifics expressed for node 210. Further, the devices 112, 114, 116 can be implemented in accordance with specifics expressed for device 240.

The base station node 210 can include a set of equipment that facilitates wireless communication (over wireless network 202) between UE (e.g., mobile device 240) and a network, such as the public switched telephone network (PSTN) 204 and/or network 206. In various embodiments, the base station node 210 can be referred to as a base transceiver station (BTS), a cell site, a radio base station (RBS), node B (in 3G networks), a base station (BS), eNodeB or eNB or enhanced node B (in LTE networks). In one embodiment, the node 210 can be guaranteed to follow 3rd Generation Partnership Project (3GPP) standards. Node 210 may or may not be in compliance with 4G standards. That is, in absence to the PCI conflict detection and resolution actions detailed herein, PCI confusion and collision problems will situationally arise in the mobile telecommunications network within which node 210 is utilized.

The base station node 210 can include one or more transmitters 220 and one or more receivers 222. Each transmitter 220 can transmit information from the base station node 210 to the wireless network 202 and/or from the base station node to network 204 and/or network 206. Each receiver 222 can receive information from network 202, 204, and/or 206.

The base station can include a set of computer program instructions 224 that are stored on at least one storage medium and that are able to be executed by one or more processors. The computer program instructions 224 can be implemented within software, firmware, or printed circuitry. Sets of computer program instructions 224 can implement a conflict detector 226 and/or a conflict correction module 228. The conflict correction module 228 can trigger one or more actions responsive to detection of a PCI conflict to resolve the conflict.

The conflict detector 226 can detect the existence of a PCI conflict among neighboring nodes. In one embodiment, the conflict detector 226 can utilize one or more ANR functions 225. Specifically, an ANR function 225, such as a reportCGI trigger 227 can invoke measurement reporting from one or more user equipment (UE) devices, such as computing device 240. That is, the reportCGI trigger 227 can cause a computing device 240 to report a PCI value and an ECGI value for each neighboring nodes.

Specifically, information about neighboring nodes can be stored in a memory represented by the neighbor database 230. For instance a guaranteed unique identifier for a node (e.g., data element 232, which can be an ECGI value) can be stored along with a PCI value, which in neighbor database 230 is not guaranteed to be unique. That is, PCI conflicts are possible. Detector 226 is designed to detect these PCI conflicts. Module 228 is designed to resolve these PCI conflicts.

Information in the neighbor database 230 can be constantly updated, as the node 210 receives measurement report information from UEs and/or as the node 210 receives responses to neighbor requests from UE (per process 140 and/or 160, for example).

The database 230 can include hardware (e.g., physical storage medium(s)) for storing the PCI information and can optionally include information management software. Any data storage format, set of data structures, storage convention can be utilized by the neighbor database 230, which is not to be limited to any one specific protocol or storage methodology.

The wireless network 202 can be used convey digitally encoded information wirelessly between mobile devices in range of the base station node 210. In various embodiments, wireless network 202 can conform to a variety of wireless communication technologies, such as Global System for Mobile Communications (GSM), Code division multiple access (CDMA), Wireless local loop (WLL), A wide area network (WAN), WiFi (any of the IEEE 802.11 family of standards), WiMAX (Worldwide Interoperability for Microwave Access), etc. In one embodiment, the wireless network 202 can be 3GPP compliant. In one embodiment, wireless network 202 can include a LTE network.

PSTN network 204 can represent a network of circuit-switched telephone networks. The PSTN 204 can consist of telephone lines, fiber optic cables, microwave transmission links, cellular networks, communications satellites, and undersea telephone cables all inter-connected by switching centers which allows telephones across the world to communicate with each other.

Network 206 can represent a packet switched network. Network 206 can conform to the internet protocol (IP) set of protocols that include a Transmission Control Protocol (TCP) and the Internet Protocol (IP). Network 206 can be public or private. For example network 206 can represent the public internet, a corporate intranet, a virtual private network (VPN), and the like. Data and/or voice (via a Voice Over IP protocol) can be conveyed over network 206.

Device 240 can be referred to as UE, as it includes at least one of a wireless transmitter 242 and wireless receiver 244, which allows the device 240 to connect to wireless network 202. Message conveyances for PCI conflict detection activities can occur over wireless network 202. Additional (and optional) receivers and/or transmitters can be included in device 240, which may permit device 240 to directly connect to network 204 and/or 206 in a wired or wireless manner in various embodiments.

The device 240 can include one or more processors 246 and one or more memory 248 components. The set of one or more processors 246 can execute computer program instructions 250 of the device 240. These instructions 250 can represent logic embedded in semiconductor, firmware embedded instructions, and/or software stored on a storage medium of device 240, such as memory 248. Device 240 can optionally include an operating system 252 as well as a set of optional applications 254.

In one embodiment, OS 252 and/or application 254 (if present for device 240) may not be aware of activities being performed related to PCI conflict detection. For example, the PCI conflict detection actions can occur at a layer of abstraction (of the OSI model) below the application layer, at which applications 254 execute. In one embodiment, the PCI conflict detection activities (per process 140, for example) can execute at the session layer (e.g., Layer 5 of the OSI model). These PCI conflict detection activities can include: in-taking a request from a serving node for neighboring nodes, transmitting requests to determine PCI values of all nodes (e.g., base stations) in range of the device 240, and transmitting PCI values of neighboring nodes to the node that issued the original request (e.g., the serving node).

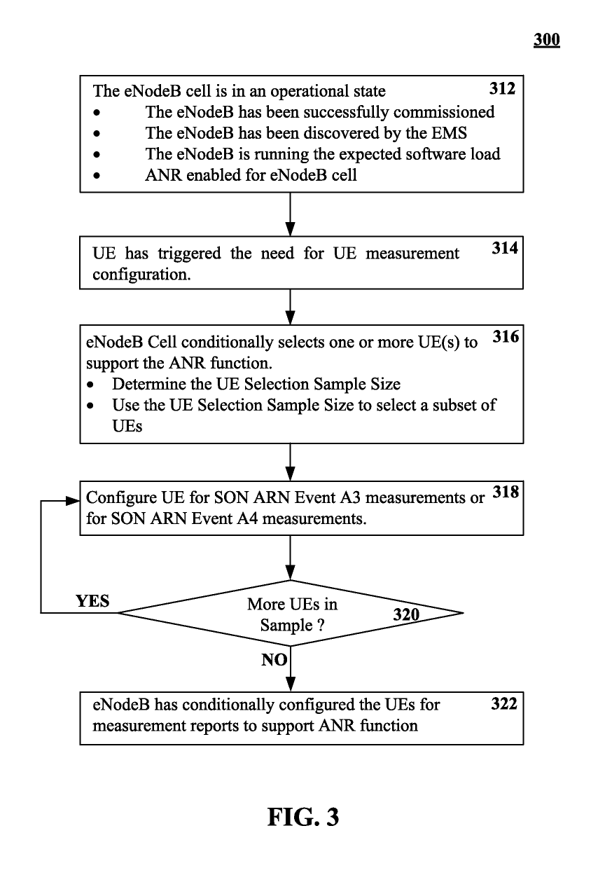

FIG. 3 illustrates an example of a method 300 for detection of PCI conflicts via UE measurement sampling in a Long Term Evolution (LTE) network in accordance with an embodiment of the inventive arrangements disclosed herein. In one embodiment, the LTE network can be a self-organizing network (SON).

For example, a base station node (e.g., eNodeB) of a SON can trigger proximate UEs to determine neighbors and to convey this neighbor information back to the eNodeB. The eNodeB can detect PCI conflicts from this information and may optionally perform zero or more PCI conflict resolution actions.

In one embodiment, nonstandard use of the reportCGI procedure in support of PCI conflict detection allows for configuration of UE reporting via Event A3 (neighbor node becomes amount of offset better than serving node) or via Event A4 (neighbor node becomes better than an absolute threshold).

Thus, a prime directive can be for a UE to discover all viable neighbor nodes for handover and/or PCI assignment. SON can define an A3 Offset for ANR, which can be independent of the A3 Offset defined for other purposes. For UEs selected for ANR measurements, the A3 Offset used to discover neighbor nodes can be lower than other A3 Offsets, which enables the ANR to discover neighbor nodes before they are needed. Additionally, the ANR can identify neighbors that have viable absolute signal strength (Event A4) to support the automatic PCI selections.

In method 300, the eNodeB can begin in an appropriate operational state, which is shown as step 312. That is, preconditions for executing method 300 can include that eNodeB be successfully commissioned, that eNodeB has been discovered by the Element Management System (a 3GPP standard EMS, for example), that eNodeB be running an expected software load, and that Automatic Neighbor Relations (ANR) functions are enabled for eNodeB. Enablement of the ANR functions can refer to a situation where a SONConfig::anrMode is in a state other than “disabled”, which can include a “preview,” “automatic,” and the like, as utilized herein.

In step 314, one or more UE can have triggered a need for a UE measurement configuration 314. The need can result from the UE having just connected to the eNodeB. The need can also result from the UE being handed-off to the eNodeB from a different base station node.

In step 316, the eNodeB can conditionally select a set of one or more UEs to support the ANR function. In this process, the eNodeB cell can determine a UE selection sample size, which is the quantity of UE's that are to be sampled. In various embodiment, a SON can be configured for a discovery sample size (if the SON is in a discovery state, for example) or for a converged sample size (if a SON is in a converged state, for example). Regardless, the UE selection sample size can be used to select a subset of UEs. Any known sampling techniques can be utilized.

To illustrate by example, in one configuration, if the sample size is set to twenty, then one out of every twenty UEs (i.e., 5%) can be selected. If a sample size is set to zero, then sampling can be disabled since the eNodeB will never select the UE. These settings can be configured to any desired value.

In various embodiments, the eNodeB can configure UEs for SON ANR event A3 measurements, for SON ANR event A4 measurements, and the like, as shown by step 318. This causes suitable measurement reports to be sent from the UE to the eNodeB cell. When more UEs exist in the sample selected by the eNode B in step 316, the method 300 can proceed from step 320 to step 318. Otherwise, the method 300 can progress from step 320 to step 322. In step 322, the UEs can be conditionally configured for measurement reports to support the ANR function.

In process 300, some attention should be given to sampling rates, which may cause disparate results for cells with significantly different traffic loads. That is, lightly loaded cells (nodes) can receive few measurement reports, while heavily loaded cells (nodes) can receive many. One solution for this situation is for the ANR function to monitor the incoming rate of measurement reports and to adjust the sampling rate to achieve a desired sample. These adjustments can occur dynamically and automatically in one contemplated embodiment. For instance, if adjusted A4 sample rates are used to measure cell (node) density, then cell density calculations can incorporate sampling rate into the algorithm as a variable.

In one embodiment, the A3 and A4 measurement can be configured in the same UE measurement report to minimize a number of reports being handled. Otherwise, each UE may send duplicate measurement reports when both the A3 and the A4 criteria/triggers are satisfied.

The flowchart, block, and pseudo code diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A base station node (eNodeB) of a long term evolution (LTE) of a mobile telecommunication system comprising:
at least one transmitter for wirelessly transmitting digitally encoded content to user equipment (UE) via radio frequency signals over the long term evolution (LTE) compliant network;
at least one receiver for wirelessly receiving digitally encoded content from user equipment (UE) via radio frequency signals over the long term evolution (LTE) compliant network; and
computer program instructions digitally encoded in at least one storage medium, wherein the computer program instructions implement a self-organizing network (SON) automatic neighbor relationship (ANR) function to detect physical layer cell identity (PCI) confusion or PCI collision situations.

2. The base station node of claim 1, wherein the computer program instructions leverages a reportCGI trigger for UE measurement reporting to detect PCI confusion or PCI collision situations.

3. The base station node of claim 1, wherein the computer program instructions cause the eNodeB to detect misconfiguration of PCI values by causing a sample of user equipment (UE) to convey PCI values of neighboring cells to the eNodeB, which the eNodeB uses to detect the PCI confusion or PCI collision situations.

4. The base station node of claim 1, wherein the ANR function cause the sample of user equipment (EU) to report “known” PCI values of neighboring cells as well as an E-UTRAN Cell Global Identifier (ECGI) values for the neighboring cells.

5. The base station node of claim 1, wherein the ANR function is compliant with a 3rd Generation Partnership Project (3GPP) standard, wherein the 3GPP standard does not guarantee that PCI confusion and PCI conflicts are able to be detected, and wherein the ANR function discovers previously undetectable neighboring cells by having the UE use a function designed per the 3GPP standard to report cells with unknown PCI values in order to report the neighboring cells that each have a known PCI value.

6. The base station node of claim 1, wherein the ANR function enables the eNodeB to identify otherwise undetectable PCI collision or collision situations.

7. The base station node of claim 1, wherein said computer program instructions when executed by at least one processor causing the base station node to:
request user equipment (UE) to send a signal strength measurement to the eNodeB with one or more “known” PCI values;
invoke the reportCGI procedure to request the user equipment (UE) to listen to a neighbor cell and learn its E-UTRAN Cell Global Identifier (ECGI) value and to report this ECGI value back to the eNodeB; and
compare the ECGI value with the known ECGI value corresponding to the PCI in a database maintained by the eNodeB, when the ECGI value and the known EGCI value are not the same to indicate that a PCI confusion or PCI collision situation exists.

8. The base station node of claim 1, wherein said computer program instructions when executed by at least one processor cause the base station node to:
listen to broadcasting of nodes within the LTE mobile communication system other than the base station node, where the listening is for nodes with a known physical-layer cell identity (PCI) value; and
receive responses from the user equipment (UE) for one or more of the nodes that were listened for by the user equipment (UE), wherein each of the responses sent to the base station node specifies a unique identifier for the node as well as a physical-layer cell identity (PCI) value for the node, wherein the received responses enable the base station node to detect PCI confusion or PCI collision situations.

9. The base station node of claim 8, wherein said computer program instructions when executed by at least one processor cause the base station node to:
in response to detecting the plurality of different neighboring nodes having the same PCI value, invoke an adjustment in the wireless mobile telecommunication system to change a PCI value of at least one of the different neighboring nodes to resolve PCI confusion or PCI conflict.

10. A method for detecting physical-layer cell identity (PCI) conflicts comprising:
triggering a set of user equipment (UE) within radio frequency range of a base station node to determine neighbor base station nodes also in radio frequency range of the corresponding user equipment (UE), wherein the base station node performs the triggering, wherein the base station node is a long term evolution (LTE) cell of a wireless mobile telecommunication system configured to periodically sample the set of user equipment (UE) to listen to known physical-layer cell identity (PCI) values;
receiving at the base station node responses from the set user equipment (UE), wherein each of the responses indicates at least one neighboring base station node by an E-UTRAN Cell Global Identifier (ECGI) and by a corresponding physical-layer cell identity (PCI) value; and
detecting that at least two base station nodes, which have different E-UTRAN Cell Global Identifier (ECGI) values, have the same physical-layer cell identity (PCI) value thereby representing a PCI confusion or PCI conflict situation in the mobile telecommunication system.

11. The method of claim 10, further comprising:
building or updating records in a neighbor database of the base station node to indicate the PCI values and ECGI values of neighboring base station nodes;
querying the records of the neighbor database at the base station node in response to detecting the PCI confusion or PCI conflict situation; and
responsive to detecting the plurality of different neighboring nodes having the same PCI value, invoking an adjustment in the wireless mobile telecommunication system to change a PCI value of at least one of the different neighboring nodes to resolve PCI confusion or PCI conflict.

12. A method for detecting physical-layer cell identity (PCI) conflicts in a self-organizing network (SON) comprising:
executing at an eNodeB of a long term evolution (LTE) telecommunications network an automatic neighbor relations (ANR) function causing the eNodeB to detect misconfiguration of physical layer cell identity (PCI) values by causing a sample of user equipment (UE) to convey PCI values of neighboring cells to the eNodeB, which the eNodeB cell uses to detect PCI confusion or PCI collision situations, wherein the ANR function leverages a reportCGI trigger for UE measurement reporting.

13. The method of claim 12, the ANR function is compliant with a 3rd Generation Partnership Project (3GPP) standard, wherein the 3GPP standard does not guarantee that PCI confusion and PCI conflicts are able to be detected, and wherein the ANR function discovers previously undetectable neighboring cells by having the UE use a function designed per the 3GPP standard to report cells with unknown PCI values in order to report the neighboring cells that each have a known PCI value.

14. The method of claim 12, wherein the ANR function enables the eNodeB to identify otherwise undetectable PCI collision or collision situations.

15. The method of claim 12, wherein preconditions for the ANR function to execute include:
the eNodeB being in an operational state, which requires the eNodeB to have been successfully commissioned, requires the eNodeB to have been discovered by an Element Management System, and requires that Automatic Neighbor Relations (ANR) be enabled for the eNodeB.

16. The method of claim 12, wherein preconditions for the ANR function to execute include that the SON is in a preview or automatic state and is not in a disabled state.

17. The method of claim 12, wherein the executing of the ANR function causes the eNodeB to:
trigger a set of user equipment (UE) within radio frequency range of the eNodeB cell to determine neighboring cells also in radio frequency range of the corresponding user equipment (UE) wireless devices;
receive at the eNodeB responses from the set of user equipment (UE), wherein each of the responses indicates at least one neighboring cell and a corresponding physical-layer cell identity (PCI) value for the neighboring cell;
build records in a neighbor database to indicate the PCI values and corresponding neighboring cells; and
query the records of the neighbor database to detect a plurality of different ones of the neighboring cells having the same PCI value as each other.

18. The method of claim 12, wherein each response from the user equipment (EU) conveyed to the eNodeB Cell comprises the PCI value of a neighboring cell as well as a E-UTRAN Cell Global Identifier (ECGI) for the neighboring cell.

19. The method of claim 18, wherein the eNodeB detects PCI confusion or PCI collision situations when two different neighboring cells have the same PCI value but have different ECGI values.

20. The method of claim 12, wherein the ANR function cause the sample of user equipment (EU) to report “known” PCI values of neighboring cells as well as the E-UTRAN Cell Global Identifier (ECGI) values for the neighboring cells.
